(19) United States
(12) Patent Application Publication
(10) Pub. No.: US 2018/0239969 A1
(43) Pub. Date: Aug. 23, 2018

(54) Free Space Detection Using Monocular Camera and Deep Learning

(71) Applicant: Ford Global Technologies, LLC, Dearborn, MI (US)

(72) Inventors: Mohsen Lakehal-ayat, Mountain view, CA (US); Matthew Chong, Mountain View, CA (US); Alexandru Mihai Gurghian, Palo Alto, CA (US)

(21) Appl. No.: 15/440,873

(22) Filed: Feb. 23, 2017

(51) Int. Cl. G06K 9/00; G06K 9/52; G06K 9/46; G06K 9/66; G06T 3/40; G06K 9/62; G05D 1/02

(52) U.S. Cl. CPC G06K 9/00798; G06K 9/52; G06K 9/4604; G06K 9/66; G06T 2207/30252; G06K 9/6256; G06K 9/6267; G05D 1/0246; G06K 2009/4666; G06T 3/40

(57) ABSTRACT

According to one embodiment, a method for detecting free space near a vehicle includes obtaining an image for a region near a vehicle. The method includes generating, based on the image, a plurality of outputs that each indicate a height for an image column of the image where a boundary of a drivable region is located. The method further includes selecting a driving direction or driving maneuver for the vehicle to stay within the drivable region based on the plurality of outputs.

### TECHNICAL FIELD

The disclosure relates generally to methods, systems, and apparatuses for free space detection and more particularly relates to methods, systems, and apparatuses for free space detection using a monocular camera image and deep learning.

### BACKGROUND

Automobiles provide a significant portion of transportation for commercial, government, and private entities. Autonomous vehicles and driving assistance systems are currently being developed and deployed to provide safety, reduce an amount of user input required, or even eliminate user involvement entirely. For example, some driving assistance systems, such as crash avoidance systems, may monitor driving, positions, and a velocity of the vehicle and other objects while a human is driving. When the system detects that a crash or impact is imminent the crash avoidance system may intervene and apply a brake, steer the vehicle, or perform other avoidance or safety maneuvers. As another example, autonomous vehicles may drive and navigate a vehicle with little or no user input. Accurate and fast detection of drivable surfaces or regions is often necessary to enable automated driving systems or driving assistance systems to safely navigate roads or driving routes.

### BRIEF DESCRIPTION OF THE DRAWINGS

Non-limiting and non-exhaustive implementations of the present disclosure are described with reference to the following figures, wherein like reference numerals refer to like parts throughout the various views unless otherwise specified. Advantages of the present disclosure will become better understood with regard to the following description and accompanying drawings where:

FIG. 1 is a schematic block diagram illustrating an implementation of a vehicle control system that includes an automated driving/assistance system;

FIG. 2 illustrates a grid for discretizing an image, according to one implementation;

FIGS. 3, 4, and 5 illustrate captured images with overlaid markers reflecting discretized locations of a drivable surface boundary, according to one implementation;

FIGS. 6, 7, 8, 9, 10, and 11 illustrate a boundary line connecting inferred boundary markers, according to one embodiment.

FIG. 12 is a schematic flow chart diagram illustrating information flow through a neural network for free space or drivable surface detection, according to one implementation;

FIG. 13 is a schematic block diagram illustrating components of a drivable region component, according to one implementation;

FIG. 14 is a schematic flow chart diagram illustrating a method for free space detection, according to one implementation; and

FIG. 15 is a schematic block diagram illustrating a computing system, according to one implementation.

### DETAILED DESCRIPTION

Localization of drivable surfaces or regions is an important part of allowing for and improving operation of autonomous vehicles or driver assistance features. For example, a vehicle must know precisely where obstacles or drivable surfaces are in order to navigate safely. However, estimating the drivable surface is challenging when no depth or prior map information is available and simple color thresholding solutions do not yield robust solutions.

Applicant has developed systems, methods, and devices for free space detection. In one embodiment, free space detection may be performed using a single camera image. For example, for a given camera image, free space detection as disclosed herein may indicate how far a vehicle can travel within each image column before hitting obstacle or leaving a drivable surface. According to one embodiment, a system for detecting free space near a vehicle includes a sensor component, a free space component, and a maneuver component. The sensor component is configured to obtain an image for a region near a vehicle. The free space component is configured to generate, based on the image, a plurality of outputs that each indicate a height for an image column of the image where a boundary of a drivable region is located. The maneuver component is configured to select a driving direction or driving maneuver for the vehicle to stay within the drivable region based on the plurality of outputs.

Further embodiments and examples will be discussed in relation to the figures below.

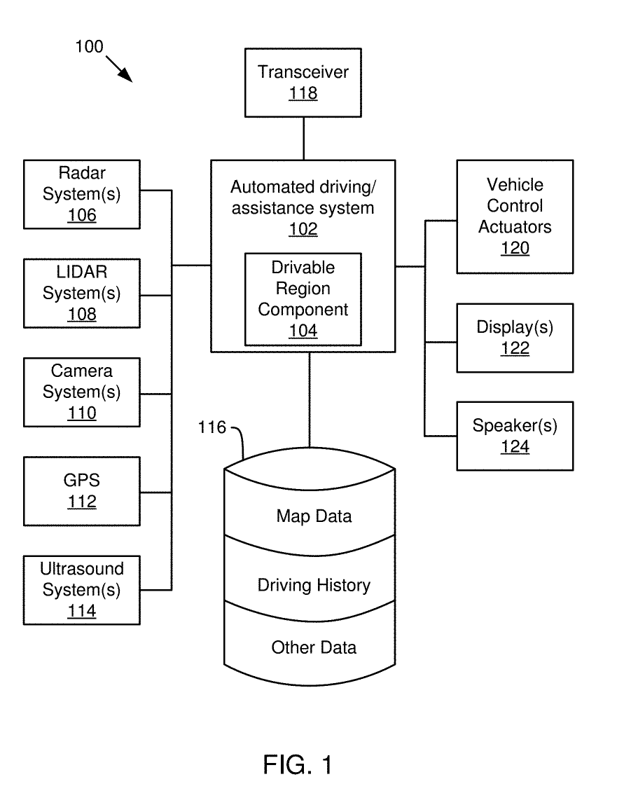

Referring now to the figures, FIG. 1 illustrates an example vehicle control system 100 that may be used to automatically localize a vehicle. An automated driving/assistance system 102 may be used to automate or control operation of a vehicle or to provide assistance to a human driver. For example, the automated driving/assistance system 102 may control one or more of braking, steering, acceleration, lights, alerts, driver notifications, radio, or any other auxiliary systems of the vehicle. In another example, the automated driving/assistance system 102 may not be able to provide any control of the driving (e.g., steering, acceleration, or braking), but may provide notifications and alerts to assist a human driver in driving safely. The automated driving/assistance system 102 may use a neural network, or other model or algorithm to detect or localize objects based on perception data gathered by one or more sensors.

It will be appreciated that the embodiment of FIG. 1 is given by way of example only. Other embodiments may include fewer or additional components without departing from the scope of the disclosure. Additionally, illustrated components may be combined or included within other components without limitation.

The vehicle control system 100 also includes one or more sensor systems/devices for detecting a presence of objects near or within a sensor range of a parent vehicle (e.g., a vehicle that includes the vehicle control system 100). For example, the vehicle control system 100 may include one or more radar systems 106, one or more LIDAR systems 108, one or more camera systems 110, a global positioning system (GPS) 112, and/or one or more ultrasound systems 114. The vehicle control system 100 may include a data store 116 for storing relevant or useful data for navigation and safety such as map data, driving history or other data. The vehicle control system 100 may also include a transceiver 118 for wireless communication with a mobile or wireless network, other vehicles, infrastructure, or any other communication system.

The vehicle control system 100 may include vehicle control actuators 120 to control various aspects of the driving of the vehicle such as electric motors, switches or other actuators, to control braking, acceleration, steering or the like. The vehicle control system 100 may also include one or more displays 122, speakers 124, or other devices so that notifications to a human driver or passenger may be provided. A display 122 may include a heads-up display, dashboard display or indicator, a display screen, or any other visual indicator which may be seen by a driver or passenger of a vehicle. The speakers 124 may include one or more speakers of a sound system of a vehicle or may include a speaker dedicated to driver notification.

In one embodiment, the automated driving/assistance system 102 is configured to control driving or navigation of a parent vehicle. For example, the automated driving/assistance system 102 may control the vehicle control actuators 120 to drive a path on a road, parking lot, driveway or other location. For example, the automated driving/assistance system 102 may determine a path based on information or perception data provided by any of the components 106-118. The sensor systems/devices 106-110 and 114 may be used to obtain real-time sensor data so that the automated driving/assistance system 102 can assist a driver or drive a vehicle in real-time.

In one embodiment, the vehicle control system 100 includes a drivable region component 104 that detects free space based on camera images. In one embodiment, the drivable region component 104 accurately detects free space based on a monocular camera image using a convolutional neural network (CNN). The CNN may receive the whole image as an input (with scaling or cropping to match the input size of the CNN) and estimate for a specific number of columns how far a vehicle can drive along that image column without violating the drivable surface or hitting obstacles. In one embodiment, the CNN “reasons” about the complete input image at once and is not applied as a local road/not-road classifier. Specifically, the CNN receives and processes each pixel of the input image together, not as part of separate bins or portions of the image, which can lead to more intelligent boundary detection.

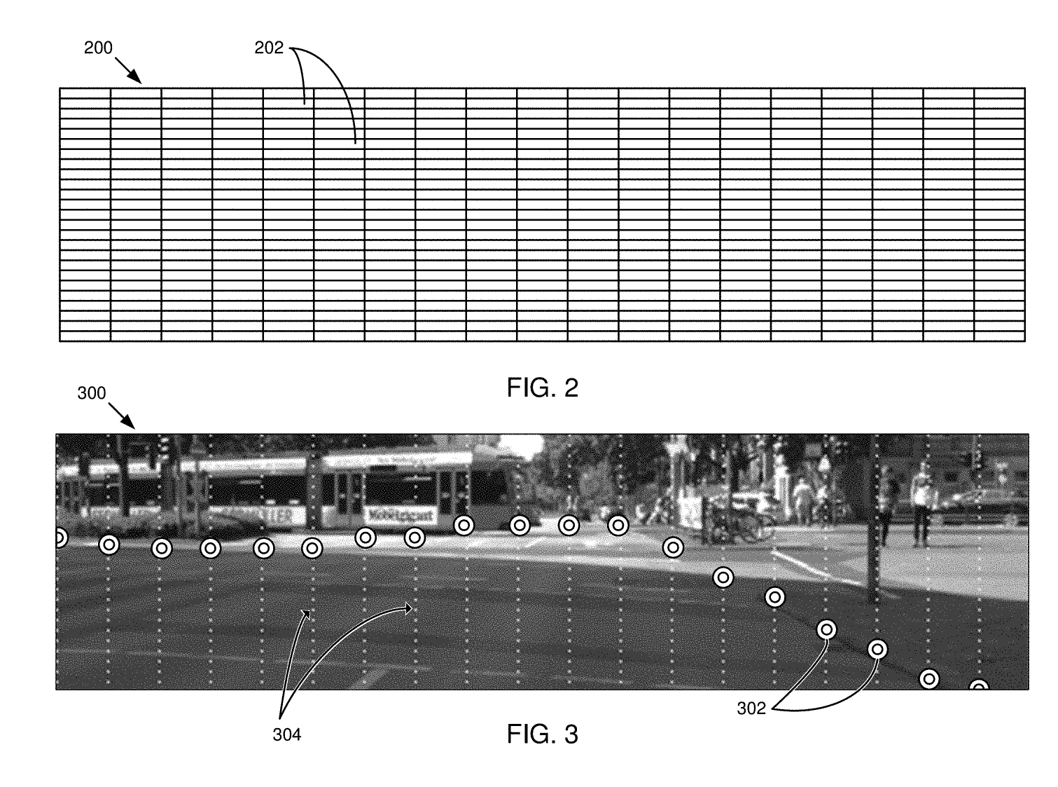

In one embodiment, the image is discretized along the width and height. FIG. 2 is a grid 200 illustrating how an image may discretized. The grid 200 includes cells 202 or bins within 19 columns and 25 rows. In one embodiment, each column is 25 pixels wide and each row is 5 pixels high, for a 475×125 sized image. This discretization is only given as an example for one embodiment and not as a limitation for all embodiments. In other embodiments, the number of columns and rows for discretization may vary as needed. For example, the number of columns may be adjusted based on a desired horizontal resolution for free space detection and the number of rows may be adjusted based on the vertical resolution for free space detection.

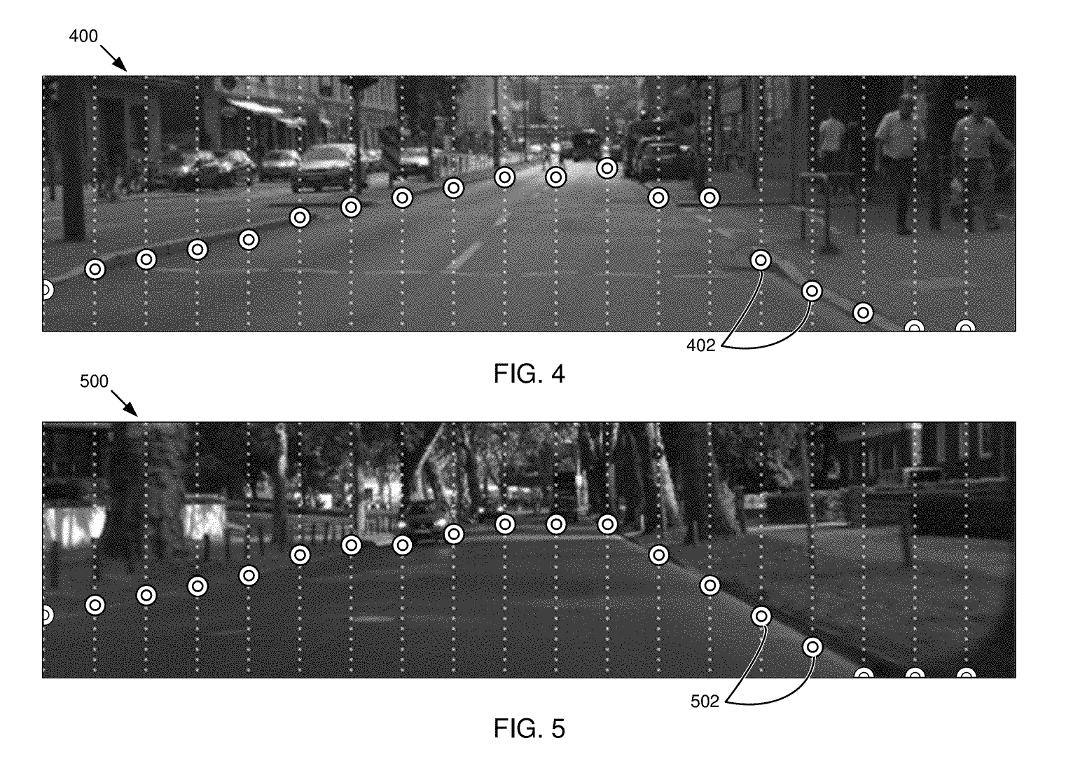

FIGS. 3-5 illustrate captured images with overlaid markers reflecting discretization based on the grid 200 of FIG. 2. FIG. 3 is an image 300 illustrating an example forward view which may be captured by an image sensor of a vehicle. The image 300 is shown overlaid with markers 302 for each image column (bounded by dotted lines 304). The markers 302 may indicate a boundary between a drivable surface (i.e., free space or drivable free space) below the marker 302 and a non-drivable surface or obstacle above or at the marker 302 for each specific image column. For example, the region below the marker 302 may be drivable surface where the vehicle may drive without leaving a driving surface or impacting an object, obstacle, person, or the like. FIG. 4 is another image 400 illustrating an example forward view with overlaid markers 402 indicating a boundary for a drivable surface. FIG. 5 is yet another image 500 illustrating an example forward view with overlaid markers 502 indicating a boundary for a drivable surface.

A goal in at least one proposed algorithm is to find the image in the discretized space that a vehicle can travel to without violating the free space/no obstacle constraint. In one embodiment, a system or method may use a convolutional neural network (CNN) to solve the problem.

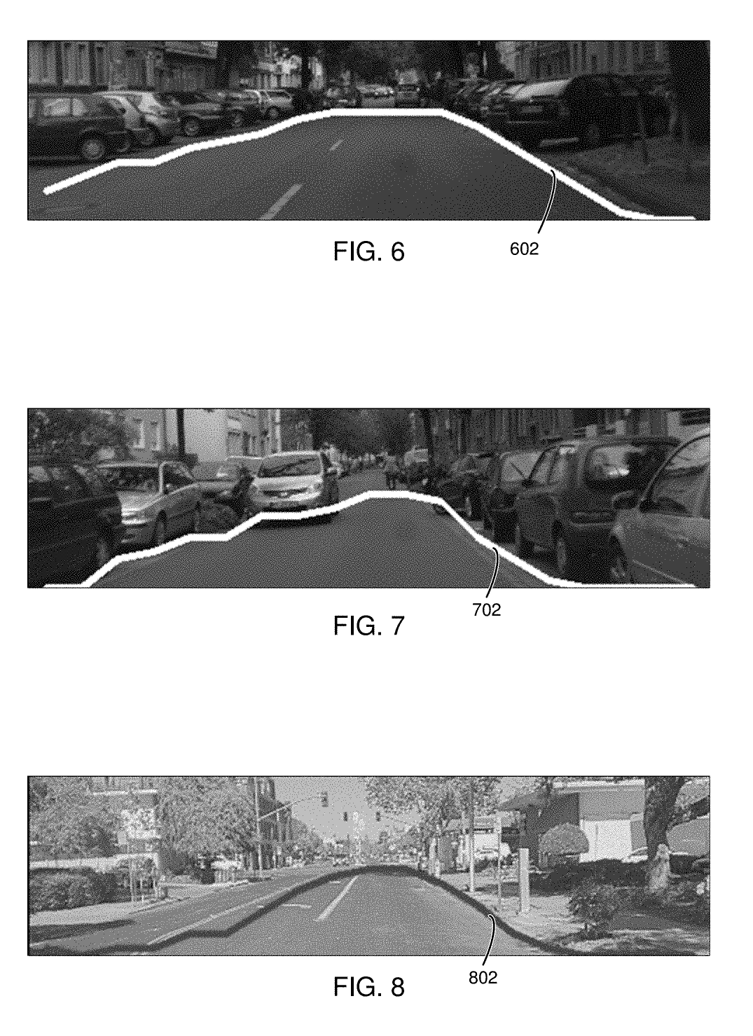

In one embodiment, the problem may be formalized as follows: The drivable distance within column i ϵ [1, 19] is modeled by the random variable Xᵢ ϵ [0, 25]. The goal is to estimate the posterior distribution P(Xᵢ=k|I), for a given image I. A neural network for estimating the probability distribution may be designed based on the commonly used AlexNet architecture as a feature extractor. A cross-entropy loss function is applied to each column individually and the final network loss is constructed by averaging the individual loss-functions. Formally, the final network loss L is obtained using Equation 1:

$$L = \frac{1}{N} {\sum }_{i = 1}^{19} {\sum }_{k = 0}^{25} {P}_{GT} ( {X}_{i} = k \vert I ) {logP}_{NN} ( {X}_{i} = k \vert I ) \qquad Equation 1$$

where P _{gt}(X=j|I) is the ground truth provided from the training data (e.g., the circle markers 302, 402, 502 in FIGS. 3-5) and where Pₙₙ(X=j|I) is the current network output for the image. The loss function is applied on top of the final fully connected layer. In testing, the network runs in real-time on the NVIDIA Drive PX1® with a 15-millisecond inference time. This approach achieves the results displayed in FIGS. 6-11. It should be noted that these inferences of drivable surface boundaries are made based on a single image without a corresponding stereo image or a previous or following image. Because only a single image is processed at a time, reductions in required processing power and processing time may be achieved. Furthermore, good performance in detecting free space can be achieved without expensive sensors such as stereo cameras or LIDAR sensors.

FIGS. 6-11 illustrate results obtained during testing. In FIG. 6 solid line 602 illustrates a boundary line connecting inferred boundary markers. The region below the solid line 602 is inferred as drivable surface. In FIG. 7 solid line 702 illustrates a boundary line connecting inferred boundary markers. In FIG. 8 solid line 802 illustrates a boundary line connecting inferred boundary markers. In FIG. 9 solid line 902 illustrates a boundary line connecting inferred boundary markers. In FIG. 10 solid line 1002 illustrates a boundary line connecting inferred boundary markers. In FIG. 11 solid line 1102 illustrates a boundary line connecting inferred boundary markers.

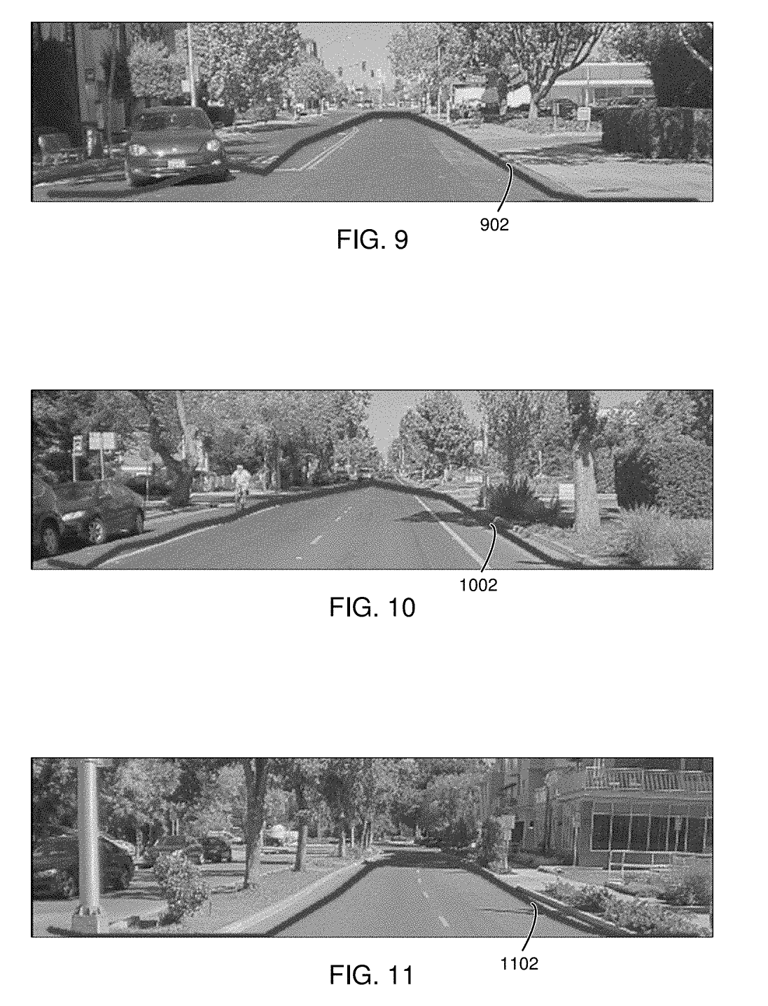

FIG. 12 is a schematic block diagram 1200 illustrating information flow through a neural network for free space or drivable surface detection, according to one embodiment. The information flow is shown with respect to a CNN 1202, one or more transformation layers 1204, and one or more output layers 1206, which may be included as part of, or accessible to, a drivable region component or other system, such as the drivable region component 104 or automated driving/assistance system 102 of FIG. 1. The drivable region component 104 may receive a camera image. The camera image may be an image from a monocular camera or may be from any other type of camera where a captured image can be analyzed separate from other images. The CNN 1202, transformation layers 1204, and/or the output layers 1206 may assume, or may have been trained based on, a specific number of image columns (i) and image rows (j). For example, the training data may have been labeled based on the assumed number of columns (i) and rows (j) and used as training data during training of the CNN 1202, transformation layers 1204, and/or the output layers 1206. In one embodiment, the discretization used in the training causes the CNN 1202, transformation layers 1204, and/or the output layers 1206 to operate based on the same discretization during usage.

The CNN 1202 may include a neural network with one or more convolutional layers. In one embodiment, a convolutional layer includes a plurality of nodes that take inputs from each of plurality of nodes from a previous layer and provide output to a plurality of nodes of a subsequent layer. The camera image may be down sampled, cropped, or the like to match the dimensions of the CNN 1202. For example, the CNN 1202 may have a fixed number of inputs. In one embodiment, the CNN 1202 includes an input layer and five or more convolutional layers.

The number of layers may vary significantly based on the image size (e.g., in pixels) optimum classification ability, or the like. The CNN 1202 processes the inputs and provides a plurality of outputs to the transformation layers 1204. The transformation layers 1204 may provide mapping from the CNN 1202 to the output layers 1206. For example, the transformation layers 1204 may simply map the output of the CNN 1202 into a form that can be processed by the output layers 1206.

In one embodiment, the output layers 1206 may include a number of nodes matching the number of image columns (i) used during training as well as a number of outputs I. The output layers 1206 may output I output values that have a value selected from J image rows. Each of the I outputs may include an integer value indicating a distance (corresponding to the discretized rows) from the bottom of the image where the first non-drivable surface or non-free space location is detected. For example, each output may indicate a location corresponding to the markers 302, 402, 502 of FIGS. 3-5 for each corresponding image. Each output may be an integer or continuous value between 0 and J, where J is the number of discretized rows. Based on these markers, a vehicle control system 100 or other system may determine a distance between a vehicle's present location and drivable surface boundary. For example, the vehicle control system 100 may infer that it can drive at least to a location corresponding to the discretized row in that specific image column before leaving a drivable surface or impacting an object. The distance to the marker can be calculated based on an angle of the camera that obtained the image, curvature of the road surface, or the like.

The embodiments disclosed herein allow for detection of free space in front of a vehicle without using depth maps such as those captured by LIDAR, RADAR, or stereo cameras. A single monocular camera can be used to capture an image of a path or space at the front of the vehicle. The image captured from monocular camera is processed as input to a CNN. The CNN discretizes the whole captured image along the width and height and equally divides it into columns/segments. The algorithm is used to find a distance in discretized image up to which the vehicle may travel to, in each column/segment, without violating free space/no obstacle constraints. A neural network for estimating the probability distribution may use AlexNet architecture as a feature extractor with an output layer that provides an output for each image column. A cross-entropy loss function may be used for each column individually and the final network loss may be constructed by averaging the individual loss-functions

The CNN 1202, transformation layers 1204, and/or output layers 1206 are trained before live or in-production usage. In one embodiment, a neural network including the CNN 1202, transformation layers 1204, and/or output layers 1206 may be trained using training data that includes an image with corresponding values for each image column as labels. For example, the label data may include 19 values each with a value indicating a height (in discretized rows) from the bottom of the image. A variety of known training algorithms, such as a back-propagation algorithm, may be used to train the neural network to provide accurate outputs. Once a sufficient level of accuracy is obtained, the neural network may be deployed within a vehicle for free space detection during driving or vehicle operation.

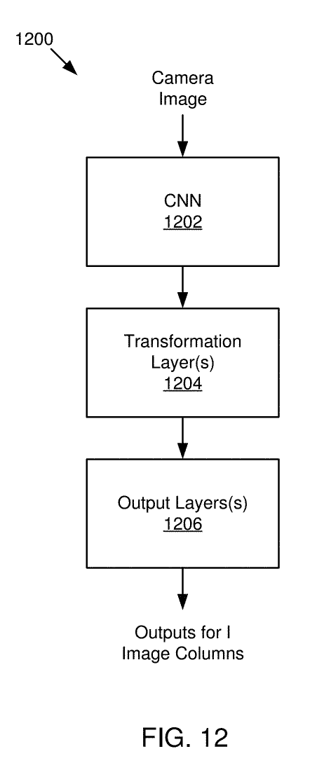

Turning to FIG. 13, a schematic block diagram illustrating components of a drivable region component 104, according to one embodiment, is shown. The drivable region component 104 may determine an amount of free space between current location of a vehicle and one or more directions in-front of, behind, or around a vehicle, according to any of the embodiments or functionality discussed herein. The drivable region component 104 includes a sensor component 1302, a free space component 1304, and a maneuver component 1306. The components 1302-1306 are given by way of illustration only and may not all be included in all embodiments. In fact, some embodiments may include only one or any combination of two or more of the components 1302-1306. For example, some of the components may be located outside or separate from the drivable region component 104.

The sensor component 1302 is obtain sensor data from one or more sensors from a system. For example, the sensor component 1302 may obtain an image for a region near a vehicle. The image may be an image from a monocular camera. The sensor component 1302 may capture an image using a non-stereo camera or other simple camera. Because some embodiments may perform free space detection without stereo or video cameras, cameras with inexpensive sensors may be used.

The free space component 1304 is configured to generate, based on the image, a plurality of outputs that each indicate a height for an image column of the image where a boundary of a drivable region is located. The free space component 1304 may include or use a neural network to generate the plurality of outputs. The neural network may include a CNN and an output layer. The output layer may output and/or generate the plurality of outputs. In one embodiment, the free space component is configured to receive each pixel of the image as input for the CNN. The image may be a scaled, cropped, or down-sampled version to match the dimensions of an input layer of the neural network.

The height or output of the neural network may indicate a discretized height corresponding to a number of discretized rows of the image. For example, the number of discretized rows of the image may be less than the number of pixel rows of the image. Processing the image based on discretized rows and/or columns can significantly improve performance, both in training and in-production accuracy and speed, because a per-pixel label or boundary is not needed. For example, the pixel-to-discretized row ratio may be 2 to 1 or more, 3 to 1 or more, 4 to 1 or more, 5 to 1 or more, or the like. As a further example, the pixel-to-discretized column ratio may be 2 to 1 or more, 3 to 1 or more, 4 to 1 or more, 5 to 1 or more, 10 to 1 or more, 15 to 1 or more, 20 to 1 or more, 25 to 1 or more, or the like. In embodiments where the number of image columns is less than the number of horizontal pixel columns (or rows) of the image significant processing savings results because outputs for only a less number of columns is needed. Furthermore, when the output has a discrete value less than the number of pixel rows, computational savings is also achieved. These performance benefits may be achieved in during both training or in-production use.

In one embodiment, the neural network includes a neural network trained based on training data that has been labeled based on a discretized format. For example, the training data may include a plurality of images of a driving environment. The training data may also include label data indicating for each image. The label data may include a discretized height for each discretized image column of each of the plurality of images that includes a value for a discretized row where a boundary for a drivable region is located. For example, the image data may include one of the images of FIGS. 3-5 and label data including 19 values, each of the 19 values may include an integer in the range 0-25 to indicate the row where a boundary, non-drivable surface, object, or the like is located. For examples, the 19 values may include integers indicating the height of each of the markers 302, 402, 502 for each image. Based on this data, the neural network may be trained.

The maneuver component 1306 is selects a driving direction or driving maneuver for the vehicle to stay within the drivable region based on the plurality of outputs generated by the free space component 1304. The driving maneuver may include any vehicle maneuver such as a braking, acceleration, turning, or another maneuver. For example, the maneuver component 1306 may determine a distance from a current location that the vehicle may drive in each image column before arriving at a boundary of a driving surface. Because the outputs may be generated in real-time, the maneuver component 1306 can account for very recent changes or information that is generated by the free space component 1304. Thus, braking to avoid objects, curbs, or other non-drivable surfaces may be possible with very little processing power and inexpensive sensors.

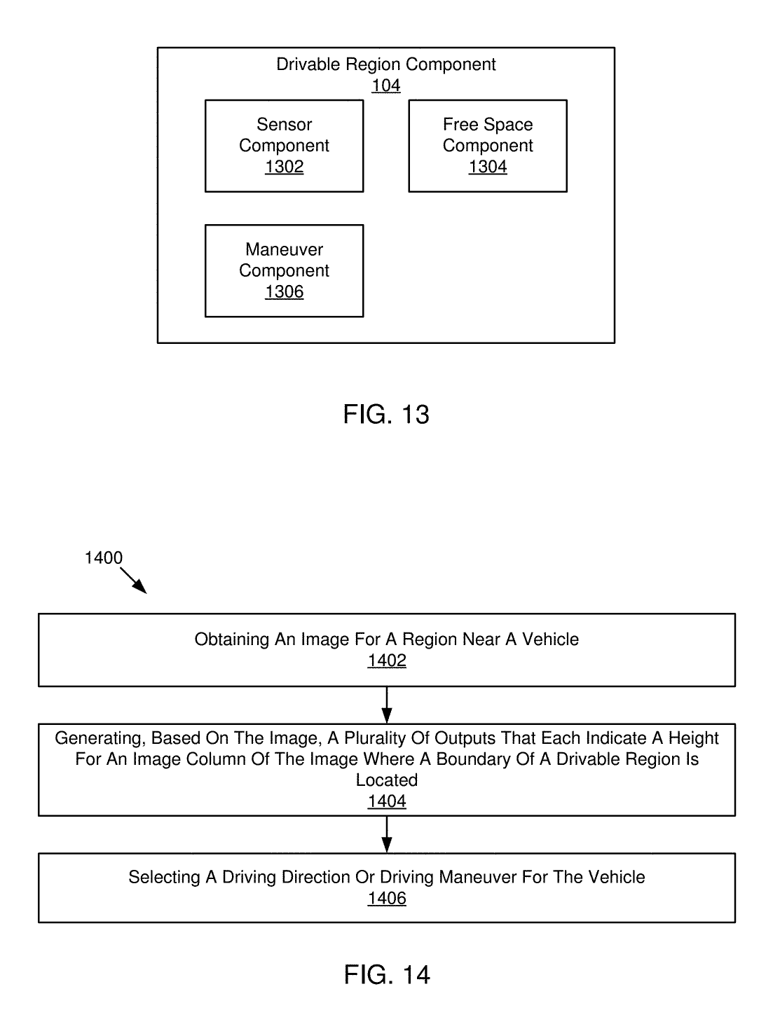

FIG. 14 a schematic flow chart diagram illustrating a method 1400 for determining a location of a boundary of a drivable region or surface. The method 1400 may be performed by a drivable region component or vehicle control system such as the drivable region component 104 of FIG. 1 or 13 or the vehicle control system 100 of FIG. 1.

The method 1400 begins and a sensor component 1302 obtains 1402 an image for a region near a vehicle. A free space component 1304 generates 1404, based on the image, a plurality of outputs that each indicate a height for an image column of the image where a boundary of a drivable region is located. A maneuver component 1306 selects 1406 a driving direction or driving maneuver for the vehicle to stay within the drivable region based on the plurality of outputs.

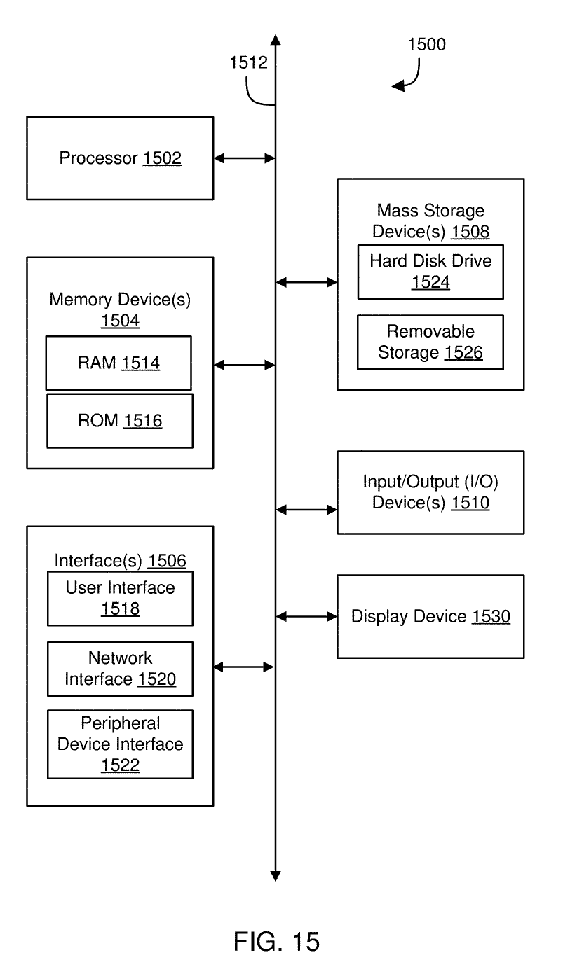

Referring now to FIG. 15, a block diagram of an example computing device 1500 is illustrated. Computing device 1500 may be used to perform various procedures, such as those discussed herein. In one embodiment, the computing device 1500 can function as a drivable region component 104, automated driving/assistance system 102, vehicle control system 100, or the like. Computing device 1500 can perform various monitoring functions as discussed herein, and can execute one or more application programs, such as the application programs or functionality described herein. Computing device 1500 can be any of a wide variety of computing devices, such as a desktop computer, in-dash computer, vehicle control system, a notebook computer, a server computer, a handheld computer, tablet computer and the like.

Computing device 1500 includes one or more processor(s) 1502, one or more memory device(s) 1504, one or more interface(s) 1506, one or more mass storage device(s) 1508, one or more Input/Output (I/O) device(s) 1510, and a display device 1530 all of which are coupled to a bus 1512. Processor(s) 1502 include one or more processors or controllers that execute instructions stored in memory device(s) 1504 and/or mass storage device(s) 1508. Processor(s) 1502 may also include various types of computer-readable media, such as cache memory.

Memory device(s) 1504 include various computer-readable media, such as volatile memory (e.g., random access memory (RAM) 1514) and/or nonvolatile memory (e.g., read-only memory (ROM) 1516). Memory device(s) 1504 may also include rewritable ROM, such as Flash memory.

Mass storage device(s) 1508 include various computer readable media, such as magnetic tapes, magnetic disks, optical disks, solid-state memory (e.g., Flash memory), and so forth. As shown in FIG. 15, a particular mass storage device is a hard disk drive 1524. Various drives may also be included in mass storage device(s) 1508 to enable reading from and/or writing to the various computer readable media. Mass storage device(s) 1508 include removable media 1526 and/or non-removable media.

I/O device(s) 1510 include various devices that allow data and/or other information to be input to or retrieved from computing device 1500. Example I/O device(s) 1510 include cursor control devices, keyboards, keypads, microphones, monitors or other display devices, speakers, printers, network interface cards, modems, and the like.

Display device 1530 includes any type of device capable of displaying information to one or more users of computing device 1500. Examples of display device 1530 include a monitor, display terminal, video projection device, and the like.

Interface(s) 1506 include various interfaces that allow computing device 1500 to interact with other systems, devices, or computing environments. Example interface(s) 1506 may include any number of different network interfaces 1520, such as interfaces to local area networks (LANs), wide area networks (WANs), wireless networks, and the Internet. Other interface(s) include user interface 1518 and peripheral device interface 1522. The interface(s) 1506 may also include one or more user interface elements 1518. The interface(s) 1506 may also include one or more peripheral interfaces such as interfaces for printers, pointing devices (mice, track pad, or any suitable user interface now known to those of ordinary skill in the field, or later discovered), keyboards, and the like.

Bus 1512 allows processor(s) 1502, memory device(s) 1504, interface(s) 1506, mass storage device(s) 1508, and I/O device(s) 1510 to communicate with one another, as well as other devices or components coupled to bus 1512. Bus 1512 represents one or more of several types of bus structures, such as a system bus, PCI bus, IEEE bus, USB bus, and so forth.

For purposes of illustration, programs and other executable program components are shown herein as discrete blocks, although it is understood that such programs and components may reside at various times in different storage components of computing device 1500, and are executed by processor(s) 1502. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

### EXAMPLES

The following examples pertain to further embodiments.

Example 1 is a method for detecting free space near a vehicle. The method includes obtaining an image for a region near a vehicle. The method includes generating, based on the image, a plurality of outputs that each indicate a height for an image column of the image where a boundary of a drivable region is located. The method includes selecting a driving direction or driving maneuver for the vehicle to stay within the drivable region based on the plurality of outputs.

In Example 2, the method of Example 1 further includes processing the image using a CNN and an output layer, wherein generating the plurality of outputs includes generating using the output layer.

In Example 3, the method of Example 2 further includes providing each pixel of the image as input for the CNN, wherein the image includes a scaled or cropped version to match the dimensions of an input layer of the CNN.

In Example 4, the CNN as in any of Examples 2-3 includes a CNN trained based on training data that includes a plurality of images of a driving environment and label data. The label data indicates a discretized height for each discretized image column of each of the plurality of images, wherein the discretized height includes a value for a discretized row where a boundary for a drivable region is located.

In Example 5, the method of Example 4 includes training the CNN.

In Example 6, the generating the plurality of outputs that each indicate the height as in any of Examples 1-5 includes generating a discretized height corresponding to a number of discretized rows of the image, wherein the number of discretized rows of the image is less than the number of pixel rows of the image.

In Example 7, the number of image columns as in any of Examples 1-6 is less than the number of pixel columns of the image.

Example 8 is computer readable storage media storing instructions that, when executed by one or more processors, cause the one or more processors to implement a method as in any of Examples 1-7.

Example 9 is a system or device that includes means for implementing a method or realizing a system or apparatus in any of Examples 1-8.

In the above disclosure, reference has been made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium, which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium.

Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. The terms “modules” and “components” are used in the names of certain components to reflect their implementation independence in software, hardware, circuitry, sensors, or the like. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s).

At least some embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure have been described above, it should be understood they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

What is claimed is:

1. A method for detecting free space near a vehicle, the method comprising:
obtaining an image for a region near a vehicle;
generating, based on the image, a plurality of outputs that each indicate a height for an image column of the image where a boundary of a drivable region is located; and
selecting a driving direction or driving maneuver for the vehicle to stay within the drivable region based on the plurality of outputs.

2. The method of claim 1, further comprising processing the image using a convolutional neural network (CNN) and an output layer, wherein generating the plurality of outputs comprises generating using the output layer.

3. The method of claim 2, further comprising providing each pixel of the image as input for the CNN, wherein the image comprises a scaled or cropped version to match the dimensions of an input layer of the CNN.

4. The method of claim 2, wherein the CNN comprises a CNN trained based on training data comprising:
a plurality of images of a driving environment; and
label data indicating a discretized height for each discretized image column of each of the plurality of images, wherein the discretized height includes a value for a discretized row where a boundary for a drivable region is located.

5. The method of claim 4, further comprising training the CNN

6. The method of claim 1, wherein generating the plurality of outputs that each indicate the height comprises generating a discretized height corresponding to a number of discretized rows of the image, wherein the number of discretized rows of the image is less than the number of pixel rows of the image.

7. The method of claim 1, wherein the number of image columns is less than the number of pixel columns of the image.

8. A system for detecting free space near a vehicle, the system comprising:
a sensor component configured to obtain an image for a region near a vehicle;
a free space component configured to generate, based on the image, a plurality of outputs that each indicate a height for an image column of the image where a boundary of a drivable region is located; and
a maneuver component configured to selecting a driving direction or driving maneuver for the vehicle to stay within the drivable region based on the plurality of outputs.

9. The system of claim 8, wherein the free space component processes the image using a convolutional neural network (CNN) and an output layer, wherein the output layer generates the plurality of outputs.

10. The system of claim 9, wherein the free space component is configured to receive each pixel of the image as input for the CNN, wherein the image comprises a scaled or cropped version to match the dimensions of an input layer.

11. The system of claim 9, wherein the CNN comprises a CNN trained based on training data comprising:
a plurality of images of a driving environment; and
label data indicating a discretized height for each discretized image column of each of the plurality of images, wherein the discretized height includes a value for a discretized row where a boundary for a drivable region is located.

12. The system of claim 8, wherein the height indicates a discretized height corresponding to a number of discretized rows of the image, wherein the number of discretized rows of the image is less than the number of pixel rows of the image.

13. The system of claim 8, wherein the number of image columns is less than the number of horizontal pixel columns of the image.

14. Non-transitory computer readable storage media storing instructions that, when executed by one or more processors, cause the one or more processors to:
obtain an image for a region near a vehicle;
generate, based on the image, a plurality of outputs that each indicate a height for an image column of the image where a boundary of a drivable region is located; and
select a driving direction or driving maneuver for the vehicle to stay within the drivable region based on the plurality of outputs.

15. The computer readable storage media of claim 14, wherein the one or more instructions cause the one or more processors to process the image using a convolutional neural network (CNN) and an output layer, wherein the instructions cause the one or more processors to generate the plurality of outputs using the output layer.

16. The computer readable storage media of claim 15, wherein the one or more instructions further cause the one or more processors to provide each pixel of the image as input for the CNN, wherein the image comprises a scaled or cropped version to match the dimensions of an input layer of the CNN.

17. The computer readable storage media of claim 15, wherein CNN comprises a CNN trained based on training data comprising:
a plurality of images of a driving environment; and
label data indicating a discretized height for each discretized image column of each of the plurality of images, wherein the discretized height includes a value for a discretized row where a boundary for a drivable region is located, wherein the label data corresponds to the plurality of outputs.

18. The computer readable storage media of claim 17, wherein the one or more instructions further cause the one or more processors to training the CNN.

19. The computer readable storage media of claim 14, wherein the one or more instructions cause the one or more processors to generate the plurality of outputs that each indicate the height by generating a discretized height corresponding to a number of discretized rows of the image, wherein the number of discretized rows of the image is less than the number of pixel rows of the image.

20. The computer readable storage media of claim 14, wherein the number of image columns is less than the number of pixel columns of the image.
